(19) United States
(12) Patent Application Publication
(10) Pub. No.: US 2025/0052341 A1
(43) Pub. Date: Feb. 13, 2025

(54) AIR CONDITIONER PIPE USING FLEXIBLE CORRUGATED PIPE

(71) Applicant: Kofulso Co., Ltd., Seoul (KR)

(72) Inventor: Seung-il OH, Seoul (KR)

(73) Assignee: Kofulso Co., Ltd., Seoul (KR)

(21) Appl. No.: 18/377,007

(22) Filed: Oct. 5, 2023

(30) Foreign Application Priority Data
Aug. 8, 2023 (KR) 10-2023-0103156

(51) Int. Cl. F16L 11/15; F16L 57/00

(52) U.S. Cl. CPC F16L 11/15; F16L 57/00

(57) ABSTRACT

The present disclosure relates to an air conditioner pipe including: a corrugated stainless steel pipe; straight pipe portions formed on both ends of the corrugated stainless steel pipe to fit connection members thereto; a knitted mesh for inserting the corrugated stainless steel pipe thereinto; and a fixing ring member for fixing each end of the knitted mesh to the corresponding straight pipe portion, wherein each straight pipe portion is formed of a straight pipe member having a higher thickness than the corrugated stainless steel pipe and is welded to the corresponding end portion of the corrugated stainless steel pipe, so that the straight pipe portion is reinforced.

### CROSS REFERENCE TO RELATED APPLICATION OF THE DISCLOSURE

The present application claims the benefit of Korean Patent Application No. 10-2023-0103516 filed in the Korean Intellectual Property Office the entire contents of which are incorporated herein by reference.

### BACKGROUND OF THE DISCLOSURE

### Field of the Disclosure

The present disclosure relates to a pipe for connecting an indoor unit and an outdoor unit of an air conditioner, more specifically to an air conditioner pipe using a flexible corrugated pipe that is capable of allowing straight pipe portions as s connection portions formed on both sides of the flexible corrugated pipe surrounded with a knitted mesh to be welded to the flexible corrugated pipe, so that while the corrugations of the flexible corrugated pipe are prevented from being deformed due to an internal pressure, the straight pipe portions are resistant to a high pressure.

### Background of the Related Art

Generally, a copper straight pipe with a given diameter is widely used as a pipe connecting an outdoor unit and an indoor unit of an air conditioner to allow a refrigerant to be circulated to an evaporator, a condenser, and a compressor.

However, the copper straight pipe with the given diameter is hard to be bent in correspondence with its installation place.

Because of such difficulties, there are many proposals in which a flexible corrugated pipe replacing the copper pipe with the given diameter is used as an air conditioner pipe. However, the conventional air conditioner pipes just stay at idea levels because they do not suggest any means capable of satisfying given properties with which a high pressure pipe has to be resistant to a high pressure. Until now, therefore, there is no product having the flexible corrugated pipe used for a pipe connecting an indoor unit and an outdoor unit.

The air conditioner pipe needs straight pipe portions with given diameters formed on both ends thereof in such a way as to be connected to the indoor unit and the outdoor unit.

Further, the corrugated stainless steel pipe has a thickness of 0.25 to 0.4 mm, and if the thickness of the corrugated stainless steel pipe is over 0.4 mm, it is hard to freely bend the corrugated stainless steel pipe on an installation site. If the straight pipe portions are formed on both ends of the corrugated stainless steel pipe, the thickness of the corrugated stainless steel pipe can be less than or equal to 0.4 mm.

To prevent the corrugated stainless steel pipe from being deformed by means of an internal pressure, as shown in FIG. 1, the present inventor has suggested a pipe that has straight pipe portions 2 formed on both ends of a high pressure corrugated stainless steel pipe 1 surrounded with a knitted net 3 made of wires and connection members 4 fitted to portions of the straight pipe portions 2 made to trumpet shapes.

A test for the pipe of FIG. 1 is performed under the internal pressure conditions required in UL's certification, and even though the corrugated stainless steel pipe has the thickness of 0.4 mm as the maximum value, the straight pipe portion 2 bursts, as shown in FIG. 2.

Through consistent tests, the present inventor has checked that if the thickness of the straight pipe portion 2 is greater than or equal to 0.5 mm, the straight pipe portion 2 satisfies the internal pressure conditions required in the UL's certification. However, in this case, the advantages the corrugated stainless steel pipe 1 has have to be abandoned, which is a dilemma.

The present inventor has made various studies of an air conditioner pipe capable of keeping the flexibility of the corrugated stainless steel pipe 1, while allowing the straight pipe portion 2 to have a thickness of 0.5 mm or more, and after that, the present inventor has finally proposed an air conditioner pipe according to the present disclosure.

### PRIOR ART LITERATURE

### Patent Literature

1. Korean Utility Medel Registration No. 20-0266061
2. Korean Patent No. 10-0269937

### SUMMARY OF THE DISCLOSURE

Accordingly, the present disclosure has been made in view of the above-mentioned problems occurring in the related art, and it is an object of the present disclosure to provide an air conditioner pipe using a flexible corrugated pipe that is capable of freely bending the flexible corrugated pipe when installed, while allowing straight pipe portions to which connection members are fitted to be resistant to a high pressure.

To accomplish the above-mentioned object, according to the present disclosure, there is provided an air conditioner pipe including: a corrugated stainless steel pipe; straight pipe portions formed on both ends of the corrugated stainless steel pipe in such a way to fit connection members thereto; a knitted mesh for inserting the corrugated stainless steel pipe thereinto; and a fixing ring member for fixing each end of the knitted mesh to the corresponding straight pipe portion, wherein each straight pipe portion is formed of a straight pipe member having a higher thickness than the corrugated stainless steel pipe in such a way as to be welded to the corresponding end portion of the corrugated stainless steel pipe, so that the straight pipe portion is reinforced.

According to the present disclosure, desirably, the corrugated stainless steel pipe may have a thickness of 0.25 to 0.4 mm, and the straight pipe member may have a thickness of 0.5 to 0.7 mm.

### BRIEF DESCRIPTION OF THE DRAWINGS

The above and other objects, features and advantages of the present disclosure will be apparent from the following detailed description of the preferred embodiments of the disclosure in conjunction with the accompanying drawings, in which:

FIG. 1 is prior art with an enlarged sectional view showing main parts of an air conditioner pipe using a corrugated stainless steel pipe with straight pipe portions formed on both ends thereof;

FIG. 2 is a photograph of prior art showing a state where the straight pipe portion is broken when a pressure test of the air conditioner pipe of FIG. 1 is performed;

FIG. 3 is a perspective view showing an air conditioner pipe according to the present disclosure;

FIG. 4 with an enlarged sectional view showing main parts of an air conditioner pipe according to an embodiment of the present disclosure;

FIG. 5 with an enlarged sectional view showing main parts of an air conditioner pipe according to another embodiment of the present disclosure; and

FIG. 6 is a side view showing an embodiment where an indoor unit and an outdoor unit are connected to each other by means of the air conditioner pipe according to the present disclosure.

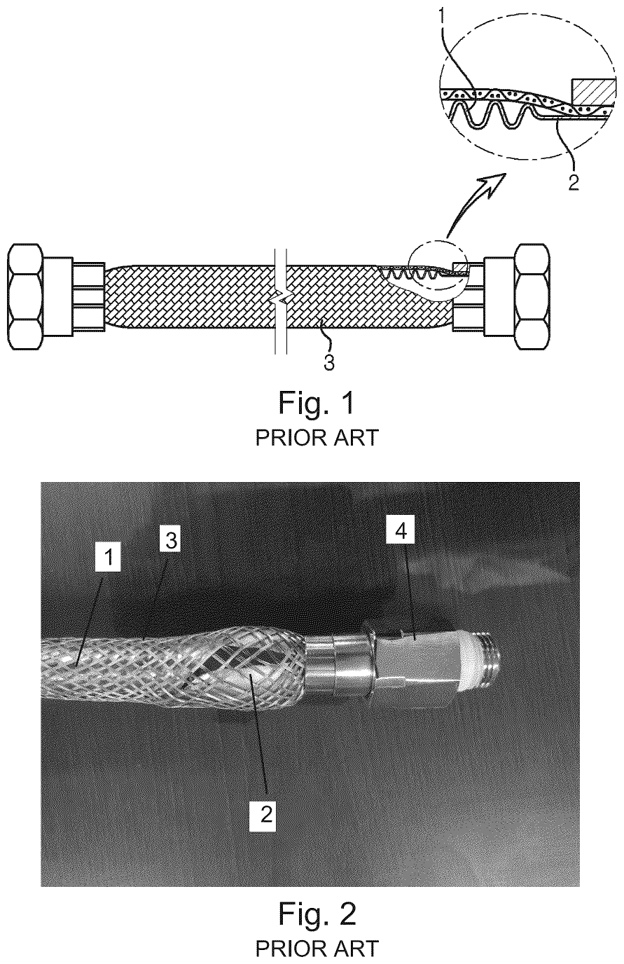

### DETAILED DESCRIPTION OF THE PREFERRED EMBODIMENTS

Hereinafter, the present disclosure will be described in detail with reference to the accompanying drawings.

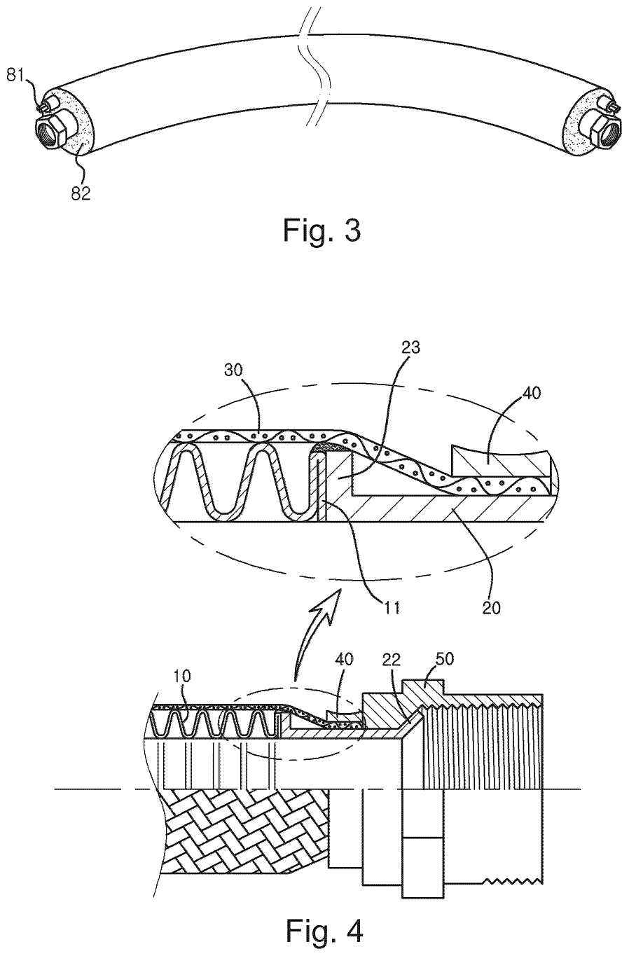

As shown in FIGS. 3 to 5, an air conditioner pipe according to the present disclosure includes: a corrugated stainless steel pipe 10; straight pipe portions formed on both ends of the corrugated stainless steel pipe 10 in such a way to fit connection members 50 thereto; a knitted mesh 30 for inserting the corrugated stainless steel pipe 10 thereinto; and a fixing ring member 40 for fixing each end of the knitted mesh 30 to the corresponding straight pipe portion, wherein each straight pipe portion is formed of a straight pipe member 20 having a higher thickness than the corrugated stainless steel pipe 10 in such a way as to be welded to the corresponding end portion of the corrugated stainless steel pipe 10, so that the straight pipe portion is reinforced.

FIG. 3 is a perspective view showing a state where an air conditioner pipe according to the present disclosure is surrounded with a thermal insulation material 82, together with an electric wire 81.

The connection members 50 for connecting an indoor unit and an outdoor unit of an air conditioner to each other have standardized coupling portions (threaded portions or threaded holes), and accordingly, the diameters of the corrugated stainless steel pipe 10 and the straight pipe members 20 constituting the air conditioner pipe according to the present disclosure are limited correspondingly to the standardized sizes of the connection members 50.

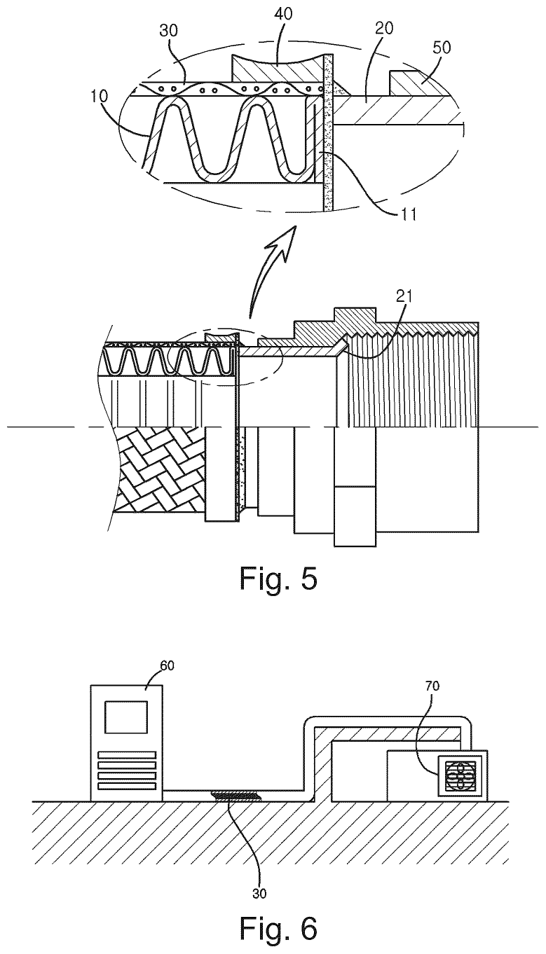

The knitted mesh 30 into which the corrugated stainless steel pipe 10 is surroundedly inserted is made by knitting wires and a fabric. The end portion of the knitted mesh 30 is fixed to the straight pipe member 20, as shown in FIG. 4, and otherwise, the end portion of the knitted mesh 30 is welded to the corrugated stainless steel pipe 10, together with the fixing ring member 40, as shown in FIG. 5, so that even if a high pressure is applied, the corrugations of the corrugated stainless steel pipe 10 can be prevented from being deformed.

The straight pipe member 20 has a bent portion 21, 22 adapted to prevent the connection member 50 fitted thereto from being uncoupled therefrom, without any loosening, in a state of being fixed to the corrugated stainless steel pipe 10 by means of the welding. As shown in FIG. 4 or 5, the bent portion 21, 22 has a trumpet shape flange.

The connection members 50 are connected to a pipe of an indoor unit 60 and a pipe of an outdoor unit 70, see FIG. 6.

Desirably, the corrugated stainless steel pipe 10 has a thickness of 0.25 to 0.4 mm, and the straight pipe member 20 has a thickness of 0.5 to 0.7 mm.

In the case where the thickness of the corrugated stainless steel pipe 10 is less than 0.25 mm, if a high pressure required by the air conditioner pipe is applied, the corrugated portions of the corrugated stainless steel pipe 10 may burst even in the state where the corrugated stainless steel pipe 10 is reinforced with the knitted mesh 30. Contrarily, in the case where the thickness of the corrugated stainless steel pipe 10 is over 0.4 mm, an excessive force in bending the corrugated stainless steel pipe 10 on a site is required

In the case where the thickness of the straight pipe member 20 is less than 0.5 mm, the straight pipe member 20 replacing the straight pipe portion burst under UL's certification conditions, as shown in FIG. 2, and contrarily, in the case where the thickness of the straight pipe member 20 is over 0.7 mm, it is hard bond 21, 22 without any damage.

FIG. 4 is a sectional view showing an embodiment of the air conditioner pipe wherein the knitted mesh 30 is fixed to the straight pipe member 20 by means of the fixing ring member 40.

As shown in FIG. 4, the valley of the corrugated stainless steel pipe 10 is cut, and next, one corrugation of the corrugated stainless steel pipe 10 is compressed flat to form a double-layered contact surface 11. After that, in a state where a bent flange 21 of the straight pipe member 20 comes into contact with the contact surface 11, the crest of the corrugated stainless steel pipe 10 and the bent flange 21 are coupled to each other by means of tungsten inert gas (TIG) welding. The portion where the TIG welding is applied desirably has an outer appearance in which the corrugated portions of the corrugated stainless steel pipe 10 are naturally continuous. The contact surface 11 allows the corrugated stainless steel pipe 10 to be double-layered to have a two times higher thickness than the original thickness thereof, so that the TIG welding can be easily performed.

FIG. 5 is a sectional view showing another embodiment of the air conditioner pipe wherein the knitted mesh 30 is fixed to the corrugated stainless steel pipe 10 by means of the fixing ring member 40.

As shown in FIG. 5, the end portions of the corrugated stainless steel pipe 10, the fixing ring member 40, and the knitted mesh 30 are primarily coupled to one another by means of TIG welding, and next, the straight pipe member 20 is secondarily coupled to the portion where the primary TIG welding is performed by means of TIG welding. In this case, the straight pipe member 20 does not have to have any flange 21.

Now, an explanation of a process of manufacturing the air conditioner pipe as shown in FIG. 4 will be given below.

The corrugated stainless steel pipe 10 for high pressure, which is surrounded with the known knitted mesh 30, is cut to a given length and forms the contact surface 11 through the compression of one corrugation. In a state where the flange 23 of the straight pipe member 20 comes into contact with the contact surface 11, the corrugated stainless steel pipe 10 and the flange 23 are coupled to each other by means of TIG welding, and the knitted mesh 30 is fixed to the straight pipe member 20 by means of the fixing ring member 40. In a state where each connection member 50 is fitted to the straight pipe member 20, the bent portion 22 is formed. As a result, the air conditioner pipe of the present disclosure is manufactured.

Further, an explanation of a process of manufacturing the air conditioner pipe as shown in FIG. 5 will be given below.

The corrugated stainless steel pipe 10 for high pressure, which is surrounded with the known knitted mesh 30, is cut to a given length, and the end portions of the fixing ring member 40, the knitted mesh 30, and the corrugated stainless steel pipe 10 are primarily coupled to one another by means of TIG welding. Next, the straight pipe member 20 is secondarily coupled to the primarily TIG welded portion by means of TIG welding. In a state where each connection member 50 is fitted to the straight pipe member 20, the bent portion 21 is formed. As a result, the air conditioner pipe of the present disclosure is manufactured.

As described above, the air conditioner pipe according to the present disclosure can keep the inherent flexibility of the corrugated pipe freely bendable on a site where the air conditioner is installed, while reinforcing the stiffness of the straight pipe member 20 to satisfy the UL's certification conditions of the air conditioner pipe, so that the air conditioner pipe using the flexible corrugated pipe, which has stayed at an idea level, becomes real as a product.

Further, the air conditioner pipe according to the present disclosure can allow the straight pipe portion weak in pressure even if reinforced with the knitted mesh to be replaced with the straight pipe member having a higher thickness than the corrugated stainless steel pipe, so that the freely bendable characteristics of the corrugated stainless steel pipe can be kept, while the high-pressure resistant straight pipe portions are being formed on both ends of the corrugated stainless steel pipe, which makes the air conditioner pipe using the flexible corrugated pipe that has stayed at an idea level become real as a product.

While the present disclosure has been described with reference to the particular illustrative embodiments, it is not to be restricted by the embodiments but only by the appended claims. It is to be appreciated that those skilled in the art can change or modify the embodiments without departing from the scope and spirit of the present disclosure.

What is claimed is:

1. An air conditioner pipe comprising:
a corrugated stainless steel pipe;
straight pipe portions formed on both ends of the corrugated stainless steel pipe to fit connection members thereto;
a knitted mesh for inserting the corrugated stainless steel pipe thereinto; and
a fixing ring member for fixing each end of the knitted mesh to the corresponding straight pipe portion,
wherein each straight pipe portion is formed of a straight pipe member having a higher thickness than the corrugated stainless steel pipe is welded to a corresponding end portion of the corrugated stainless steel pipe, to reinforce the straight pipe portion.

2. The air conditioner pipe according to claim 1, wherein the corrugated stainless steel pipe has a thickness of 0.25 to 0.4 mm, and the straight pipe member has a thickness of 0.5 to 0.7 mm.

3. The air conditioner pipe according to claim 1, wherein where a valley of the corrugated stainless steel pipe is cut, one corrugation of the corrugated stainless steel pipe is compressed flat to form a double-layered contact surface having a crest, and where a flange of the straight pipe member is in contact with a contact surface, the crest of the corrugated stainless steel pipe and the flange are coupled to each other by means of tungsten inert gas (TIG) welding.

4. An air conditioner pipe comprising:
a corrugated stainless steel pipe;
straight pipe portions formed on both ends of the corrugated stainless steel pipe to fit connection members thereto;
a knitted mesh for inserting the corrugated stainless steel pipe thereinto; and
a fixing ring member for fixing each end of the knitted mesh to a corresponding end of the corrugated stainless steel pipe,
wherein each straight pipe portion is formed of a straight pipe member having a higher thickness than the corrugated stainless steel pipe and is welded to a corresponding end portion of the corrugated stainless steel pipe, so that the straight pipe portion is reinforced.

5. The air conditioner pipe according to claim 4, wherein the corrugated stainless steel pipe has a thickness of 0.25 to 0.4 mm, and the straight pipe member has a thickness of 0.5 to 0.7 mm.

6. The air conditioner pipe according to claim 4, wherein the end portions of the corrugated stainless steel pipe, the fixing ring member, and the knitted mesh are primarily coupled to one another by means of TIG welding, and the straight pipe member is secondarily coupled to the primarily TIG welded portion by means of TIG welding.
